(19) United States
(12) Patent Application Publication
(10) Pub. No.: US 2004/0076753 A1
(43) Pub. Date: Apr. 22, 2004

(54) Impregnation of porous substrates

(75) Inventor: Duarte R. Sousa, White Rock (CA)

Correspondence Address: SEED INTELLECTUAL PROPERTY LAW GROUP PLLC, 701 FIFTH AVE, SUITE 6300, SEATTLE, WA, 98104-7092, US

(73) Assignee: Ballard Power Systems Inc., Burnaby (CA)

(21) Appl. No.: 10/254,455

(22) Filed: Sep. 25, 2002

(51) Int. Cl. B05D 3/12

(52) U.S. Cl. 427/322; 118/117

(57) ABSTRACT

Methods and apparatus are disclosed for impregnating a resiliently compressible, porous substrate with a material by: compressing the substrate through a calendering apparatus; contacting the compressed substrate with a fluid comprising the material; maintaining the calendered substrate in contact with the fluid while the calendered substrate expands, thereby impregnating the substrate with the material; and drying the impregnated substrate. Such impregnated substrates find particular application as gas diffusion layers for anodes and cathodes used in fuel cells.

### BACKGROUND OF THE INVENTION

1. Field of the Invention

The present invention generally relates to impregnation of a porous, resiliently compressible substrate with a material by calendering and immersion in a fluid comprising the material and, more particularly, to impregnation of an electrode substrate for an electrochemical fuel cell with a polymeric material to impart hydrophobicity thereto.

2. Description of the Related Art

Fuel cells have the capability of generating electricity from a fuel and an oxidant in a clean and efficient manner, and have been the focus of considerable attention. In polymer electrolyte membrane (“PEM”) fuel cells, the membrane electrode assembly (“MEA is a consolidated assembly of a planar anode, a planar cathode, and a PEM sandwiched therebetween. Each electrode (i.e., anode and cathode) includes a porous, electrically conductive substrate and a catalyst layer (typically, comprising finely divided platinum) bonded thereto. The anode and cathode are also referred to as gas diffusion electrodes (“GDEs”) and their substrates as gas diffusion layers (“GDLs”). The GDLs, in addition to allowing reactants to readily diffuse to the catalyst layer, must also allow reaction products to readily diffuse away from the catalyst layer.

Water management is an important aspect of the operation of a fuel cell. Water is formed at the cathode when oxygen combines with protons and electrons. Also, water is typically added to both fuel and oxidant feed streams to maintain the PEM in a sufficiently hydrated state (for proton conductivity). It is important that no water be allowed to accumulate in any portion of either the anode or cathode GDL to the point of flooding the same. Such flooding impedes the diffusion of reactants to the catalyst layers and the diffusion of reaction products away from the catalyst layers, thereby, negatively affecting fuel cell performance. Such flooding can also compromise fuel cell life and cold start capability.

Effective water management can be achieved by, for example, treating the anode and cathode GDLs to render them hydrophobic. This is accomplished by, for example, impregnating the GDLs with small diameter particles of Teflon® (polytetrafluoroethylene) which, generally, are subsequently cross-linked by heating the impregnated GDLs so as to dry and sinter the same. A method for rendering GDLs hydrophobic is described in U.S. Pat. No. 6,183,898.

One current method used to effect the impregnation is dip coating a GDL in a bath comprising an aqueous suspension of Teflon® particles, and passing the coated GDL through squeeze (i.e., press) rolls (calendering). Surfactants may be used to improve penetration of the porous GDL by the Teflon®. A squeeze roll pressure is selected with the goal of effecting a uniform penetration of the GDL by the Teflon®. The above process of impregnating a GDL with Teflon® is referred to as teflonating the GDL. While Teflon® is capable of providing the degree of GDL hydrophobicity desired, the above-described method for impregnating a GDL with Teflon® has limitations.

More specifically, such a method yields a degree of Teflon® impregnation and a Teflon® concentration lacking consistency, especially in the z-direction (i.e., perpendicular to the major planar surfaces of the GDL). One consequence of this is less than optimum water management, as well as fuel cell and fuel cell stack operating characteristics impacted thereby. Existing low-cost, high-volume manufacturing methods are also characterized by limited raw material and process consistency and repeatability which, in turn, limits process capability and consistency of cell-to-cell performance. The formation of foam on the squeeze rolls and transfer thereof to the GDL web can be another problem associated with impregnation.

Accordingly, there remains a need in the art for improved high-volume manufacturing methods for impregnating a porous planar substrate with a material, in particular, for teflonating GDLs used for the anode and cathode of a fuel cell. The present invention fulfills these needs and provides further related advantages.

### BRIEF SUMMARY OF THE INVENTION

In brief, the present invention is directed to impregnating a porous, resiliently compressible substrate with a material by calendering and contacting the same with a fluid comprising the material, then drying the impregnated substrate.

Accordingly, in one embodiment, a method is disclosed for impregnating a porous, resiliently compressible substrate with a material, comprising the steps of: compressing the substrate through a calendering apparatus; contacting the compressed substrate with a fluid comprising the material; and maintaining the calendered substrate in contact with the fluid while the calendered substrate expands, thereby impregnating the substrate with the material.

In another embodiment, a method is disclosed wherein the porous substrate is in sheet form, and is electrically conductive and suitable for use as a GDL for the anode or cathode of a fuel cell, and the material impregnating the substrate is a hydrophobic polymer.

In another aspect, the present invention discloses an apparatus for impregnating a porous, resiliently compressible substrate with a material according to the above-disclosed method. The apparatus comprises a container adapted to be filled with fluid so as to provide a fluid bath, wherein the fluid comprises the material, dissolved or dispersed therein. The apparatus further comprises a calendering means and a substrate guide means, and may further comprise a drying means, a substrate feed means, and/or a substrate collection means. The calendering means forms a nip and, during operation, is in contact with or submerged into the fluid bath so that the substrate contacts the fluid upon exiting the nip.

These and other aspects of this invention will be evident upon reference to the following detailed description of the invention and accompanying drawings. To this end, a number of articles and patent documents are cited herein to aid in understanding certain aspects of this invention. Such documents are hereby incorporated by reference in their entirety.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic illustration of a prior art apparatus for impregnating a substrate, where the substrate is directed through a bath of impregnating fluid, between two press rolls, then to a drying and a collection means.

FIG. 2 is a schematic illustration of an apparatus for impregnating a substrate, according to an embodiment of the present invention, where the substrate is directed between two press rolls partially submerged in a bath of impregnating fluid.

FIG. 3 is a schematic illustration of the apparatus of FIG. 2, but including substrate guide means for directing the substrate through the bath of impregnating fluid along a serpentine path.

FIG. 4 is a schematic illustration of an apparatus for impregnating a substrate, according to an embodiment of the present invention, where the substrate is directed between two press rolls fully submerged in a bath of impregnating fluid.

FIG. 5 is a schematic illustration of the apparatus of FIG. 4, but including additional substrate guide means for directing the substrate from the press rolls, then laterally through the bath of impregnating fluid.

FIG. 6 is a schematic illustration of the apparatus of FIG. 5, but including additional substrate guide means for directing the substrate through the bath of impregnating fluid along a serpentine path.

FIG. 7 is a schematic illustration of an apparatus for impregnating a substrate, according to an embodiment of the present invention, where the substrate is directed onto a conveyor belt, then between the conveyor belt and a rotating press roll.

FIG. 8 is a schematic illustration of the apparatus of FIG. 7, but including additional substrate guide means for directing the substrate through the bath of impregnating fluid along a serpentine path.

FIG. 9 is a schematic illustration of an apparatus for impregnating a substrate, according to an embodiment of the present invention, where the substrate is directed between a press roll and arcuate pressure shoe.

FIG. 10 is a schematic illustration of the apparatus of FIG. 9, but including additional substrate guide means for directing the substrate through the bath of impregnating fluid along a serpentine path.

### DETAILED DESCRIPTION OF THE INVENTION

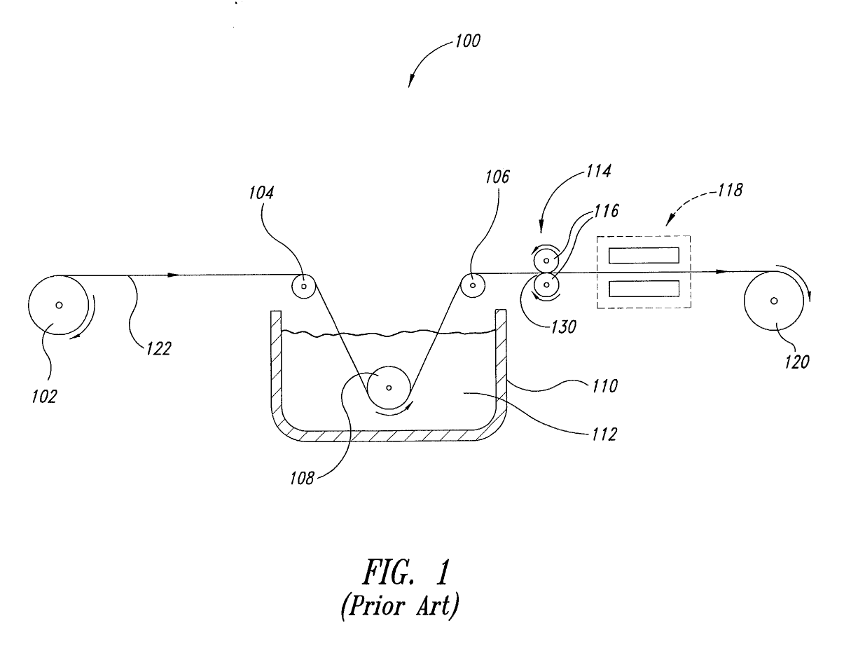

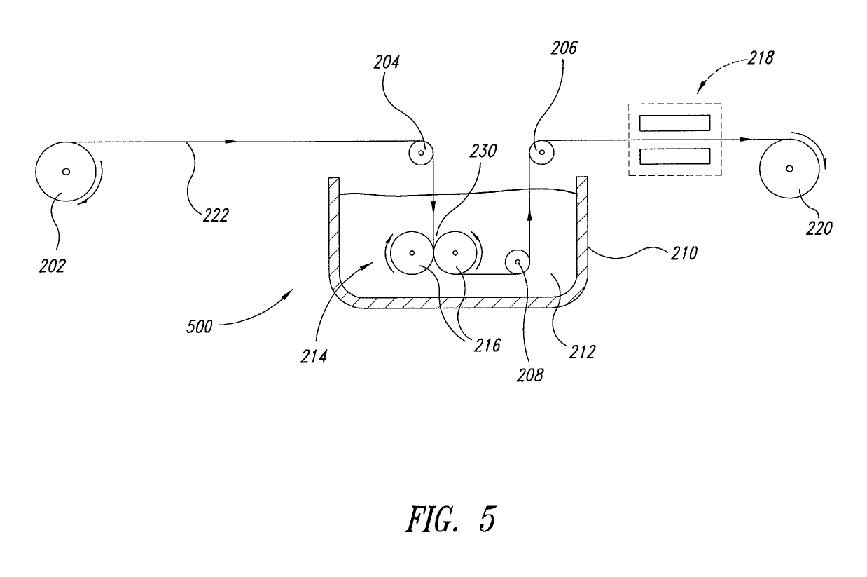

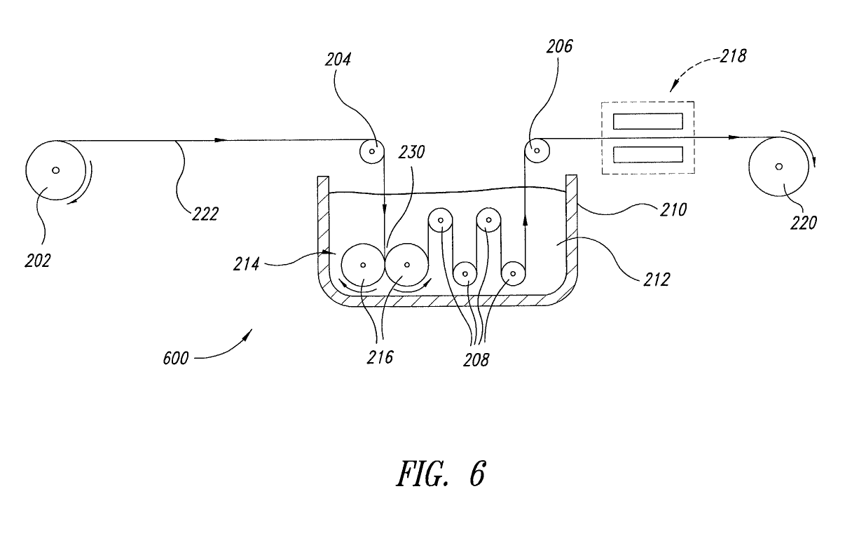

As noted above, the present invention is generally directed to methods and apparatus for impregnating a porous, resiliently compressible substrate with a material by calendering the substrate, contacting the same with a fluid comprising the material, and then drying the impregnated substrate. Specific details of certain embodiments of the invention are set forth in the following description and illustrated in FIGS. 1-10 to provide a thorough understanding of such embodiments. One skilled in the art, however, will understand that the present invention may have additional embodiments, or may be practiced without several of the details described in the following description and illustrated in the figures.

In one embodiment, disclosed is a method for impregnating a resiliently compressible, porous substrate with a material, where the method comprises the steps of: 1) compressing the substrate through a calendering apparatus; 2) contacting the compressed substrate with a fluid comprising the material; and 3) maintaining the calendered substrate in contact with the fluid while the calendered substrate expands, thereby impregnating the substrate with the material. In related embodiments, respectively, the method further comprises the step of drying the impregnated substrate; the substrate is in sheet form; and steps 1) and 2) are carried out simultaneously.

As used herein, the expression “resiliently compressible” refers to a substrate that can be flattened by a compressive force and then expand within a relatively short period of time (for purposes of the disclosed methods) of having been flattened so as to be restored to a thickness substantially greater than the reduced thickness, if not substantially equal to its original thickness.

The choice of particular calendering apparatus is not essential to the present method and apparatus, and persons skilled in the art will readily be able to choose suitable such apparatus for a given application. For example, a pair of press rollers may be employed. Alternatively, calendering between a press roll and a conveyor belt, as described in U.S. Pat. No. 5,051,122, for example, may be employed. This method may provide a nip having a larger area relative to press rollers. As another example, the calendering apparatus may comprise a press roll and an arcuate pressure shoe adjacent thereto. The roll and shoe are positioned, during operation, to form a nip therebetween having a length five to ten times longer than the nip formed between two press rolls. Such calendering apparatus is described in U.S. Pat. Nos. 5,772,848 and 5,238,537, for example.

In one embodiment, the calendering apparatus comprises two press rolls forming a nip therebetween. The calendering apparatus may have hard or compliant calendering surfaces. Hard calendering surfaces include metal surfaces, such as chrome-plated press rollers, for example. Compliant calendering surfaces include elastic surfaces, such as plastic or rubber. For example, rubber calendering surfaces may be employed that are characterized by a durometer reading of from about 15 to about 90 Shore A.

In the present method, the nip of the calendering apparatus is at least in contact with, and can be entirely submerged, in the bath of fluid comprising the material. Such an arrangement of the calendering apparatus in relation to the fluid bath allows for substrates to be calendered and contacted with an impregnating fluid in the compressed state.

The substrate is flattened by the calendering apparatus to a desired degree. In the process, a substantial portion of the gas (e.g., air) initially present in the porous substrate is displaced. The flattened substrate sheet exits the nip of the calendering apparatus and, soon thereafter or immediately, is contacted by the impregnating fluid. While not wishing to be bound by theory, it is believed that, as the flattened (i.e., compressed) substrate sheet expands, a suction force is thereby created that acts upon the fluid, drawing it into the porous interior of the substrate. Other forces may also contribute to impregnation of the porous substrate, such as capillary action, for example. Thus, surfactants or wetting agents may be added to the fluid to enhance impregnation, if desired.

The present method is well suited for impregnating GDL substrates with a material to impart hydrophobicity thereto. Accordingly, in related embodiments the material used for impregnating a substrate sheet is a hydrophobic polymer, and the impregnating fluid is either a solution or a suspension of the polymer. Polytetrafluoroethylene is one such hydrophobic polymer. Suitable impregnating fluids include aqueous suspensions of Teflon®, which are milky white, hydrophobic liquids having very small particles (typically, 0.05 to 0.5 microns in diameter) of polytetrafluoroethylene resin suspended therein, and can be characterized as negatively charged colloids. Examples of such aqueous suspensions that are 60% (by weight) resin are designated as “Teflon 30” and “Teflon 30B” and commercially available from E. I. du Pont de Nemours & Co., Inc., Wilmington, Del.

Suitable GDL substrates are electrically conductive, and include carbon fiber papers and woven or non-woven carbon fiber webs. The manufacture of such substrates is well known to those skilled in the art and is described, for example, in U.S. Pat. Nos. 5,998,057 and 6,183,898.

As one skilled in the art may readily appreciate, the present method may be carried out as either a continuous or a batch process. Accordingly, in one embodiment, the porous substrate forms a substantially continuous web and is impregnated, as disclosed herein, by a continuous process. In another embodiment, the porous substrate is in the form of, for example, an individual sheet and is impregnated, as disclosed herein, by a batch process.

For a given substrate and end-use application, persons skilled in the art can readily determine process parameters suitable for achieving a desired level of impregnation. For example, the degree of impregnation may be controlled by such factors as the extent of compression of the substrate during calendering and/or varying the contact time between the compressed and expanding substrate with the impregnating fluid. Similarly, the process temperatures employed are not essential to the present method; for example, teflonation is typically performed with the fluid bath maintained at a temperature ranging from about 10° to about 30° C.

In another aspect, the present invention discloses apparatus for carrying out the above-disclosed methods. For comparison purposes, FIG. 1 schematically illustrates an apparatus for carrying out a presently used method, previously described herein, for impregnating a GDL with Teflon® particles to render the GDL hydrophobic and suitable for use in a fuel cell.

In apparatus 100, the substrate guide means 104, 106 and 108 direct the substrate sheet 122 into and out of the impregnating fluid bath 112. Substrate sheet 122 is directed between the press rolls 116 of the calendering apparatus 114 and then to the drying means 118. Significantly, the substrate sheet 122 is calendered after emerging from the fluid bath 112.

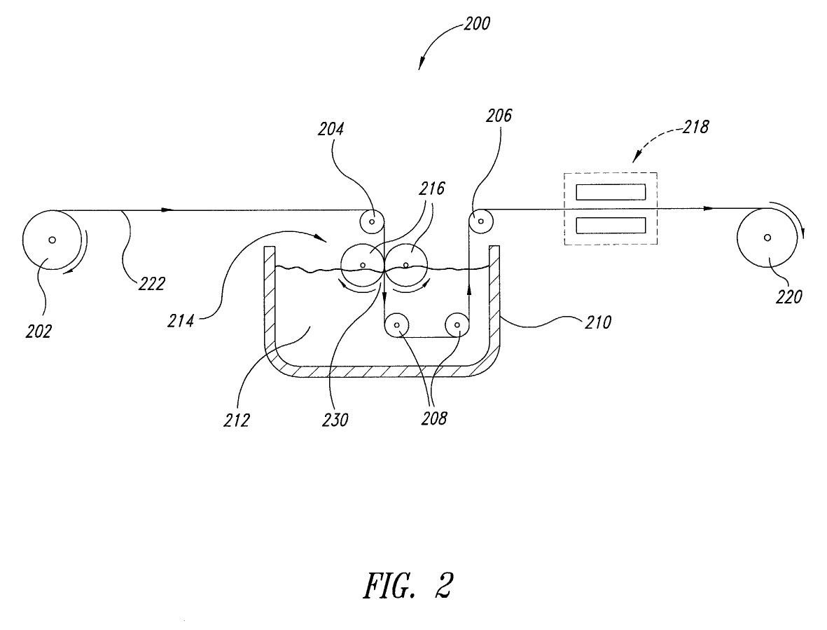

One embodiment of the present apparatus is illustrated in FIG. 2. As shown, the substrate guide means 204, 206 and 208 direct the substrate sheet 222 into and out of the impregnating fluid bath 212. The substrate sheet 222 is calendered in the nip formed between the press rolls 216 of the calendering apparatus 214 and is impregnated as it passes through fluid bath 212 before being directed to the drying means 218. While press rolls 216 are shown in horizontal alignment in FIG. 2, this is for illustration purposes only. The spatial orientation of the press rolls is not essential to the present apparatus. However, note that, unlike the apparatus of FIG. 1, the nip of press rolls 216 is in contact with fluid bath 212. Thus, substrate sheet 222 is at least partially submerged in the fluid bath as it exits the nip of press rolls 216.

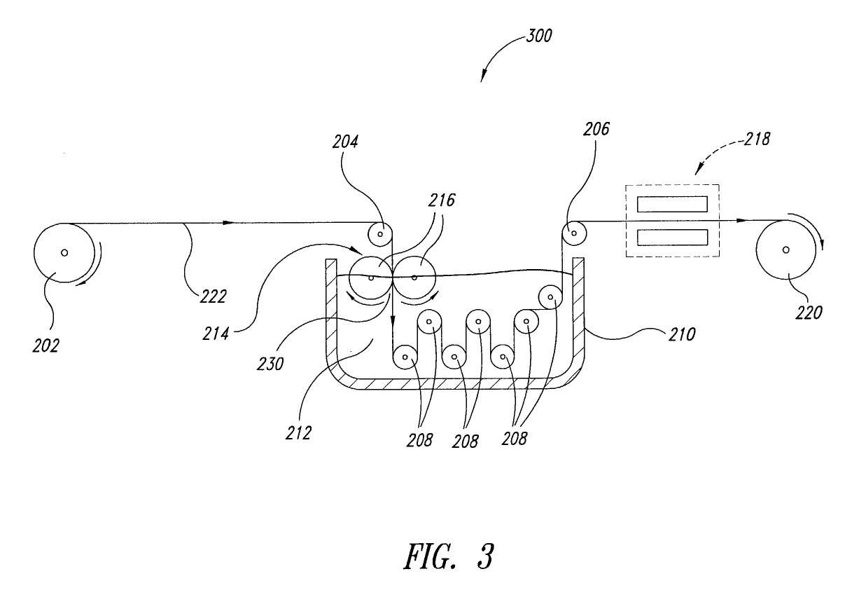

If desired, the guide path of the substrate sheet may be configured to provide an extended residence time in the fluid bath, which may allow more control over the extent of impregnation of material into the substrate sheet. FIG. 3 is a schematic illustration of an apparatus similar to that disclosed in FIG. 2. Apparatus 300, as shown in FIG. 3, includes additional submerged substrate guide means 208 for directing the substrate sheet 222 through the bath of impregnating fluid along a serpentine path. The serpentine path provides for an extended residence time in fluid 212, as compared to the guide path in the apparatus of FIG. 2.

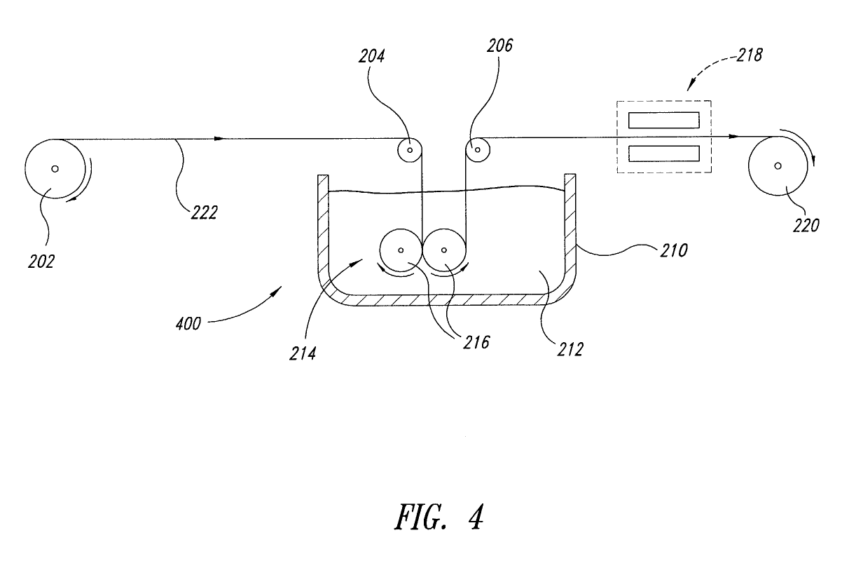

FIGS. 4-6 are schematic illustrations of other embodiments of the present apparatus. Apparatus 400, 500 and 600, include calendering apparatus 214 wherein the nip between press rolls 216 is fully submerged, rather than partially submerged in the bath of impregnating fluid 212. In apparatus 500 and 600, substrate guides 206, 208 cooperate to extend the guide path of substrate sheet 222 through fluid path 212; apparatus 600 provides for a serpentine path.

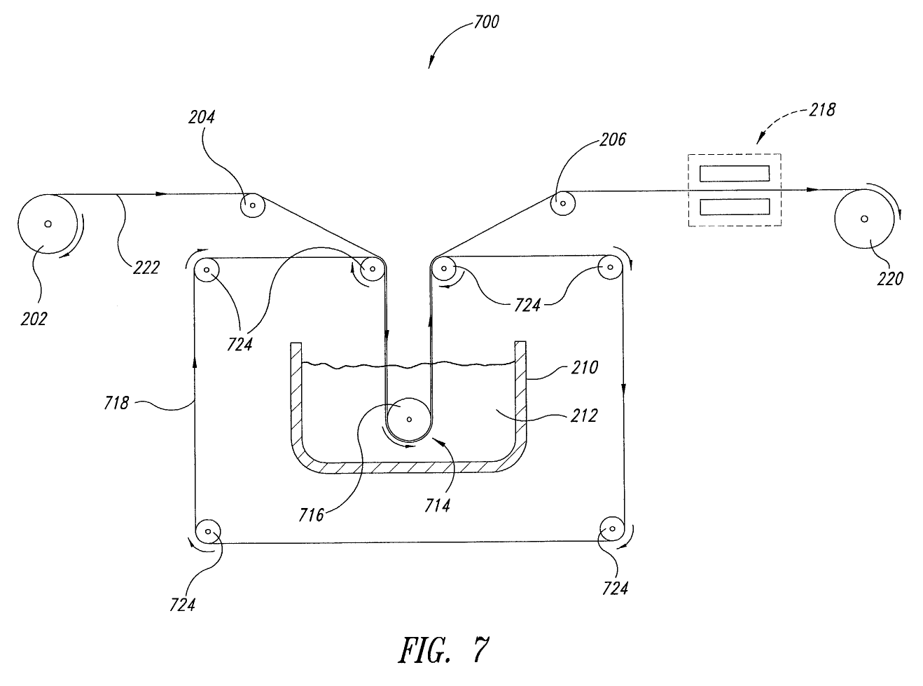

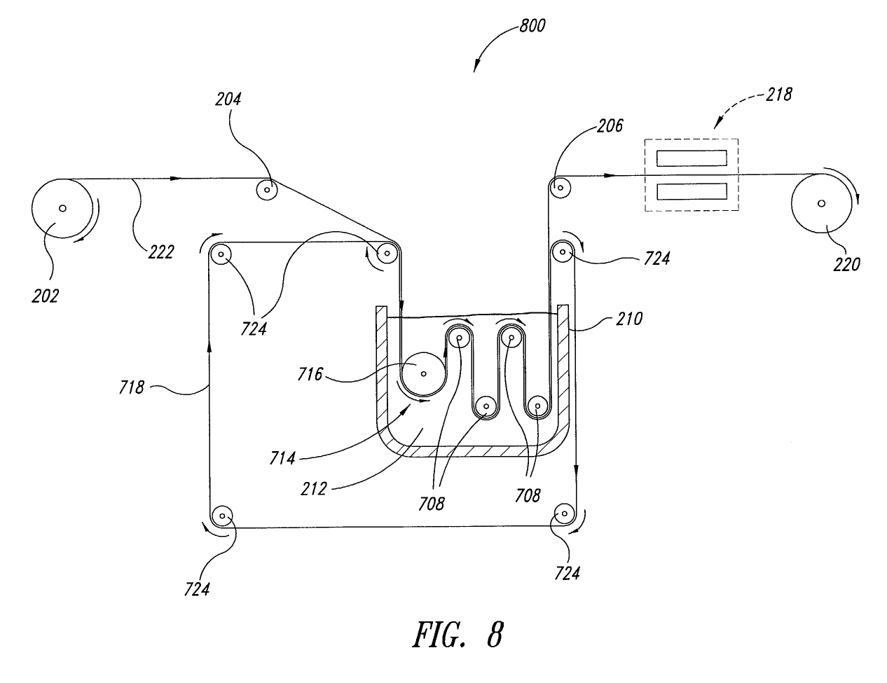

FIGS. 7 and 8 are schematic illustrations of further embodiments of the present apparatus. Apparatus 700 and 800 each include a submerged calendering apparatus 714 that comprises a press roll 716 and a conveyor belt 718. As shown, the conveyor belt 718 moves in a continuous loop, being positioned and directed by conveyor belt and guide means 724. In operation, the rotational speed of the press roll 716 and translational speed of the conveyor belt 718 may be matched such that there is substantially no slip between the press roll 716 and conveyor belt 718. Methods and means for such matching of speeds are well known to those skilled in the art. The nip of calendering apparatus 714 formed between the cooperating elements of press roll 716 and conveyor belt 718 is submerged in the bath of impregnating fluid 212. In FIG. 8, conveyor belt 718 and substrate guides 708 also cooperate to form a serpentine path for substrate sheet 222 in fluid bath 212.

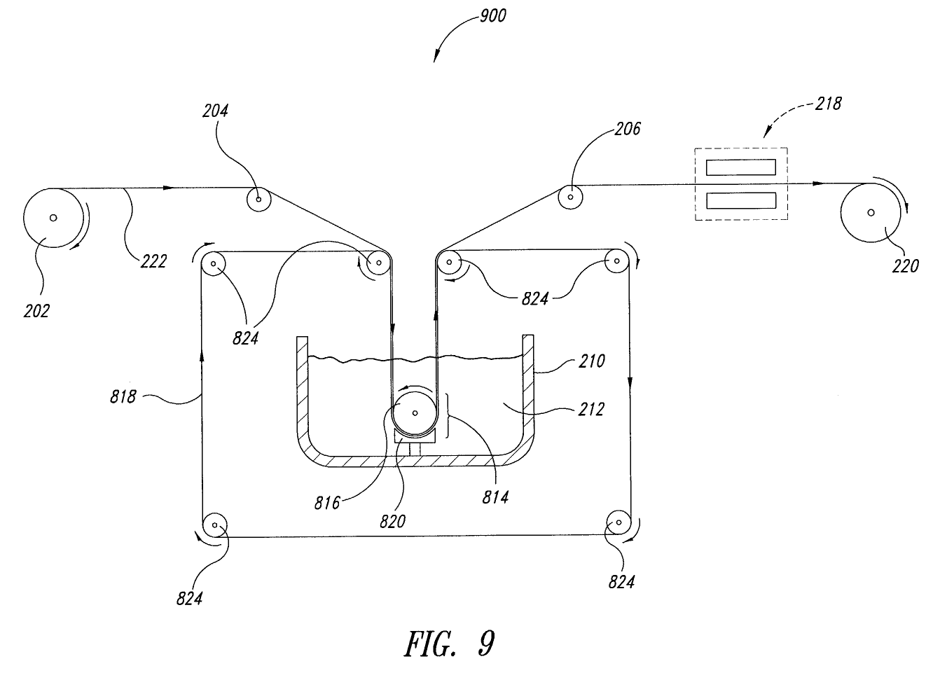

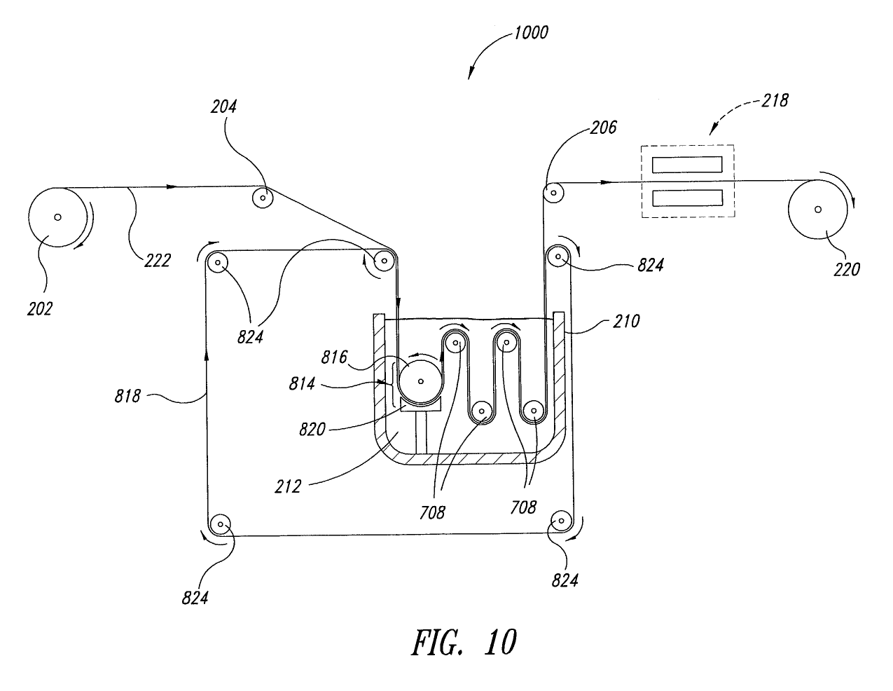

FIGS. 9 and 10 are schematic illustrations of further related embodiments of the present apparatus. Apparatus 900 and 1000 each include a calendering apparatus 814 that comprises a press roll 816 and arcuate pressure shoe 820. Also included is a protective belt 818. As shown, the protective belt 818 moves in a continuous loop, being positioned and directed by protective belt guide means 824. In FIG. 10, as in FIG. 8, conveyor belt 718 and substrate guides 708 also cooperate to form a serpentine path for substrate sheet 222 in fluid bath 212.

In FIGS. 1-10, web handling equipment, such as sheet or web feed, collection and guide means, have not been illustrated in detail, but are understood to be present. The selection of web handling equipment is not essential to the present apparatus, and persons of ordinary skill can readily select suitable such equipment for a given application. Also, as would be understood by those skilled in the art, the above-disclosed apparatus may be adapted to operate either in a continuous or batch-wise mode, the means and methods for effecting such operation also being well known. For example, the substrate feed and collection means shown in FIGS. 1-10 are suitable for continuous processing. For batch operation, an individual sheet feed and collection device would be used, such devices being known and readily commercially available. As another example, where the disclosed apparatus are adapted for continuous processing of a substrate sheet, such apparatus may comprise an accumulator.

Further, drying means, such as the substrate drying means included in the above-disclosed apparatus, are well known in the art. As one example, a substrate sheet, unsupported or supported on a conveyor belt, can be passed through the radiant heat and/or forced-air oven.

The present method and apparatus provide for the impregnation of resiliently compressible, porous substrates, in a manner suitable for high-volume manufacturing. Further, the present method and apparatus may result in more consistent levels of impregnation, particularly in the z-dimension, as well as higher process repeatability.

In addition, some substrate materials, such as carbon fiber GDL materials, for example, may have broken or otherwise stray filaments protrude from their major surface(s). Such protruding filaments can be problematic in certain applications. The present method and apparatus may also flatten any actual or potentially protruding filaments during calendering, embedding them in the interior of the substrate material. This can mitigate or eliminate the potential problem caused by protruding substrate filaments

From the foregoing, it will be appreciated that, although specific embodiments of the present invention have been described herein for purposes of illustration, various modifications may be made without deviating from the spirit and scope of the invention. Accordingly, the present invention is not limited except as by the appended claims.

1. A method for impregnating a resiliently compressible, porous substrate with a material, comprising the steps of:
(a) compressing the substrate through a calendering apparatus;
(b) contacting the compressed substrate with a fluid comprising the material; and
(c) maintaining the calendered substrate in contact with the fluid while the calendered substrate expands, thereby impregnating the substrate with the material.

2. The method of claim 1 further comprising the step of drying the impregnated substrate.

3. The method of claim 1 wherein the substrate is in sheet form.

4. The method of claim 1 wherein steps (a) and (b) are carried out simultaneously.

5. The method of claim 1 wherein the material is a hydrophobic polymer.

6. The method of claim 5 wherein the fluid is a suspension of the polymer.

7. The method of claim 6 wherein the polymer is polytetrafluoroethylene.

8. The method of claim 5 wherein the fluid comprises a wetting agent or a surfactant.

9. The method of claim 1 wherein the substrate forms a substantially continuous web.

10. The method of claim 1 wherein the substrate is electrically conductive.

11. The method of claim 10 wherein the substrate comprises carbon fiber.

12. The method of claim 1 wherein the substrate is a gas diffusion electrode layer.

13. The method of claim 1 wherein the calendering apparatus comprises a press roll.

14. The method of claim 13 wherein the press roll comprises a pair of press rolls.

15. The method of claim 14 wherein the pair of press rolls have compliant surfaces.

16. The method of claim 15 wherein the compliant surfaces have a durometer reading of from about 15 to about 90 Shore A.

17. The method of claim 13 wherein the calendering apparatus further comprises a conveyor belt, the conveyor belt and the press roll adapted to form a nip therebetween.

18. The method of claim 13 wherein the calendering apparatus further comprises an arcuate pressure shoe, the pressure shoe and the press roll adapted to form a nip therebetween.

19. The method of claim 1 wherein, in step (a), the compressed substrate is partially submerged in the fluid.

20. The method of claim 1 wherein, in step (a), the compressed substrate is entirely submerged in the fluid.

21. The method of claim 1 wherein the fluid is maintained at a temperature ranging from about 10° C. to about 30° C.

22. An apparatus for impregnating a resiliently compressible, porous substrate with a material comprising:
a container adapted for holding a fluid comprising the material;
a calendering means that forms a nip, wherein the calendering means is situated in relation to the container so that, during operation, the nip contacts the fluid;
a substrate guide means operably associated with the container for directing the substrate to the calendering means.

23. The apparatus of claim 22, further comprising feed means for directing a substantially continuous web of the substrate to the calendering means.

24. The apparatus of claim 22 further comprising a drying means for drying the impregnated substrate.

25. The apparatus of claim 22, further comprising a collection means for receiving an impregnated substrate from the substrate guide means.

26. The apparatus of claim 22 wherein the substrate guide means describes a serpentine guide path downstream of the calendering means.

27. The apparatus of claim 22 wherein, during operation, the nip of the calendering means is submerged in the fluid.

28. The apparatus of claim 22 wherein the calendering means comprises two press rolls.

29. The apparatus of claim 22 wherein the calendering means comprises a press roll and a continuous conveyor belt wrapping partially around the press roll so as to form the nip therebetween.

30. The apparatus of claim 22 wherein the calendering means comprises a press roll and an arcuate pressure shoe forming the nip therebetween.
